(19) United States
(12) Patent Application Publication
(10) Pub. No.: US 2008/0039262 A1
(43) Pub. Date: Feb. 14, 2008

(54) Vehicle drivetrain having hydraulic power assist

(75) Inventors: Michael G. Cronin, Peoria, IL (US); Brian D. Kuras, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/501,699

(22) Filed: Aug. 10, 2006

(51) Int. Cl. F16H 47/04

(52) U.S. Cl. 475/73

(57) ABSTRACT

A drivetrain for use in a mobile vehicle is disclosed. The drivetrain may have a combustion engine with a mechanical output, a ground engaging traction device, and a primary transmission unit. The primary transmission unit may be connected to transmit power from the mechanical output to the ground engaging traction device. The drive train may also have a hydraulic power assist unit operatively connected to the mechanical power output to selectively drive the combustion engine.

### TECHNICAL FIELD

The present disclosure relates generally to a vehicle drivetrain and, more particularly, to a vehicle drivetrain having hydraulic power assist.

### BACKGROUND

Machines such as, for example, wheel loaders, on and off-highway trucks, motor graders, and other heavy equipment are used to perform many tasks. To effectively perform these tasks, the machines require an engine that provides significant torque through a transmission to one or more ground engaging devices. The transmission must provide a range of gearing in order to allow the machine to work at different speeds while keeping the engine operating within a desired operating range. For this purpose, the machines typically include a multi-speed mechanical transmission, a hydraulic continuously variable transmission (CVT) having a pump and a fluid motor, an electric CVT having a generator and an electric motor, or a hybrid transmission (e.g., a combination of the afore-mentioned technologies) connected between the engine and ground engaging devices in a series or parallel configuration.

Although the engine/transmission configurations described above may be adequate for some situations, when the engine is undersized such as in a hybrid or CVT application, the response of the drive system to changing loads may be slow. For example, when disproportionate heavy loads (e.g., loads that are heavier than the average load placed on the engine, for which the engine is sized) are suddenly applied to the drivetrain, the engine may be slow in providing the demanded torque output. Similarly, when a decrease in machine speed or output torque is desired and the machine is equipped with a typical CVT, the available retarding from the engine and transmission may be inadequate in some situations, requiring the manual use of service brakes.

One attempt to improve response of a vehicle drivetrain is described in U.S. Pat. No. 5,887,674 (the '674 patent) issued to Gray, Jr. Mar. 30, 1999. The '674 patent describes a drivetrain for a vehicle that includes a fluidic motor and a pump interconnected in a continuous loop. A first conduit connects the inlet of the fluidic motor to the outlet of the pump, and a second fluid conduit connects the inlet of the pump to the outlet of the fluidic motor. A gas/liquid fluid accumulator is in communication with the first conduit, while a low pressure reservoir is in communication with the second fluid conduit. An engine sized to match the average torque demand of the vehicle is employed to drive the pump. A motor controller controls displacement of the fluidic motor in accordance with a sensed power demand, and a pump controller controls displacement of the pump in response to a pressure of the fluid in the accumulator.

As a driver of the vehicle described in the '674 patent issues a command for increased power to wheels of the vehicle (e.g., depresses an accelerator pedal), displacement of the hydraulic motor is increased. The increased flow of fluid associated with increased motor displacement can not be quickly supplied by the engine until its speed is increased and, therefore, the accumulator supplies the increased fluid flow while the engine speed is increasing. An increase in the displacement of the motor will result in a pressure drop in the system and in the accumulator. In response to the drop in system pressure, the pump is controlled to decrease its displacement and, subsequently, the load applied to the engine, so that the speed of the engine will rapidly increase to the new power demand. When engine speed reaches the appropriate speed, the displacement of the pump is increased to satisfy the fluid power requirement and regain system set-point pressure.

A drop in power demand is handled in a similar manner as a power demand increase. That is, as the displacement of the motor is reduced, system pressure increases, which inherently adds load to the engine and subsequently drives the speed of the engine to the required new lower level.

Although the use of the accumulator described in the '674 patent may improve response during changing loads transmitted from wheels to an engine by a hydraulic CVT, it may be limited in its applicability to other drivetrain configurations. In particular, because step change mechanical-type and electric continuously variable-type transmissions do not utilize pumps or fluid motors to transmit power from an engine to the wheels of a vehicle, there may be no way to charge an accumulator or utilize charged fluid from the accumulator in such a system. In addition, because only part of a vehicle's total power flows through the hydraulic portion of a dual path hybrid transmission (e.g., a transmission having a mechanical power flow path and a parallel hydraulic power flow path), the effectiveness of the accumulator in such a system would be minimal. Further, even if use of the accumulator could be effectively implemented into the hydraulic power flow path of the dual path hybrid transmission, control thereof would be very complex.

The disclosed vehicle drivetrain is directed to overcoming one or more of the problems set forth above.

### SUMMARY OF THE INVENTION

In one aspect, the present disclosure is directed to a drivetrain. The drive train may include a combustion engine having a mechanical output, a ground engaging traction device, and a primary transmission unit. The primary transmission unit may be connected to transmit power from the mechanical output to the ground engaging traction device. The drivetrain may also include a hydraulic power assist unit operatively connected to the mechanical power output to selectively drive the combustion engine.

In another aspect, the present disclosure is directed to a method of propelling a vehicle. The method may include combusting fuel to produce a mechanical output and directing power through a first flow path to propel the vehicle. The first flow path may originate from the mechanical output. The method may also include selectively directing power through a second flow path to pressurize a fluid. The second flow path may be completely different from the first flow path and originate from the mechanical output. The method may also include storing the pressurized fluid and selectively directing the stored pressurized fluid back through the second flow path to propel the vehicle.

### BRIEF DESCRIPTION OF THE DRAWINGS

FIG. 1 is a diagrammatic illustration of an exemplary disclosed machine; and

FIG. 2 is a diagrammatic and schematic illustration of an exemplary disclosed power system for use with the machine of FIG. 1.

### DETAILED DESCRIPTION

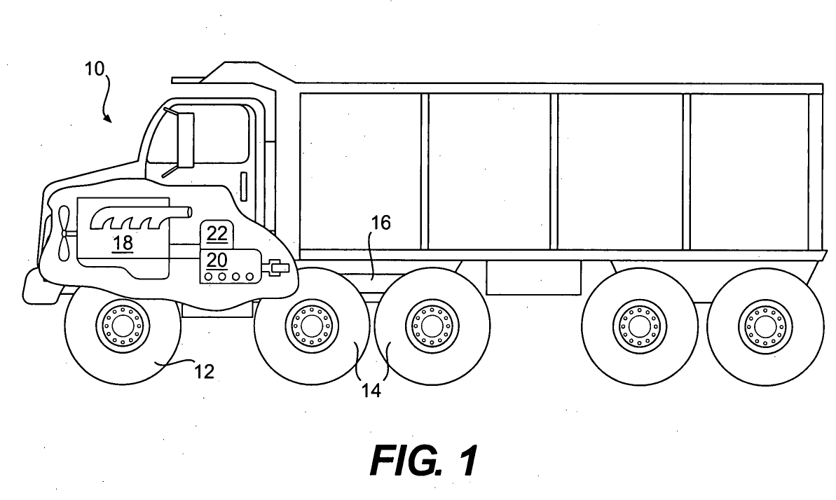

FIG. 1 illustrates an exemplary machine 10. Machine 10 may be a mobile vehicle that performs some type of operation associated with an industry such as mining, construction, farming, transportation, or any other industry known in the art. For example, machine 10 may be a load moving vehicle such as an on or off-highway truck, a wheel loader, a motor grader, or any other load moving vehicle. Machine 10 may alternatively be a marine vessel, a passenger vehicle, or any other suitable operation-performing machine. Machine 10 may include a forward traction device 12, a rear traction device 14, a frame 16 connecting forward and rear traction devices 12, 14, a power source 18, a transmission 20, and a hydraulic assist unit 22. It is contemplated that a torque converter (not shown) may or may not be situated between power source 18 and transmission 20, if desired.

Both forward and rear traction devices 12, 14 may include one or more wheels located on each side of machine 10 (only one side shown). Alternatively, forward and/or rear traction devices 12, 14 may include tracks, belts, or other traction devices known in the art. Any of forward and rear traction devices 12, 14 may be driven and/or steerable.

Frame 16 may include any structural unit that supports movement of work machine 10. Frame 16 may be, for example, a stationary base frame connecting traction devices 12, 14, power source 18, and transmission 20; a movable frame member of a linkage system; or any other frame known in the art.

Power source 18 may produce a mechanical power output and embody an internal combustion engine such as, for example, a diesel engine, a gasoline engine, a gaseous fuel-powered engine, or any other type of engine apparent to one skilled in the art. Power source 18 may, alternatively, embody a non-combustion source of power such as a furnace, a battery, a fuel cell, a motor, or any other suitable source of power.

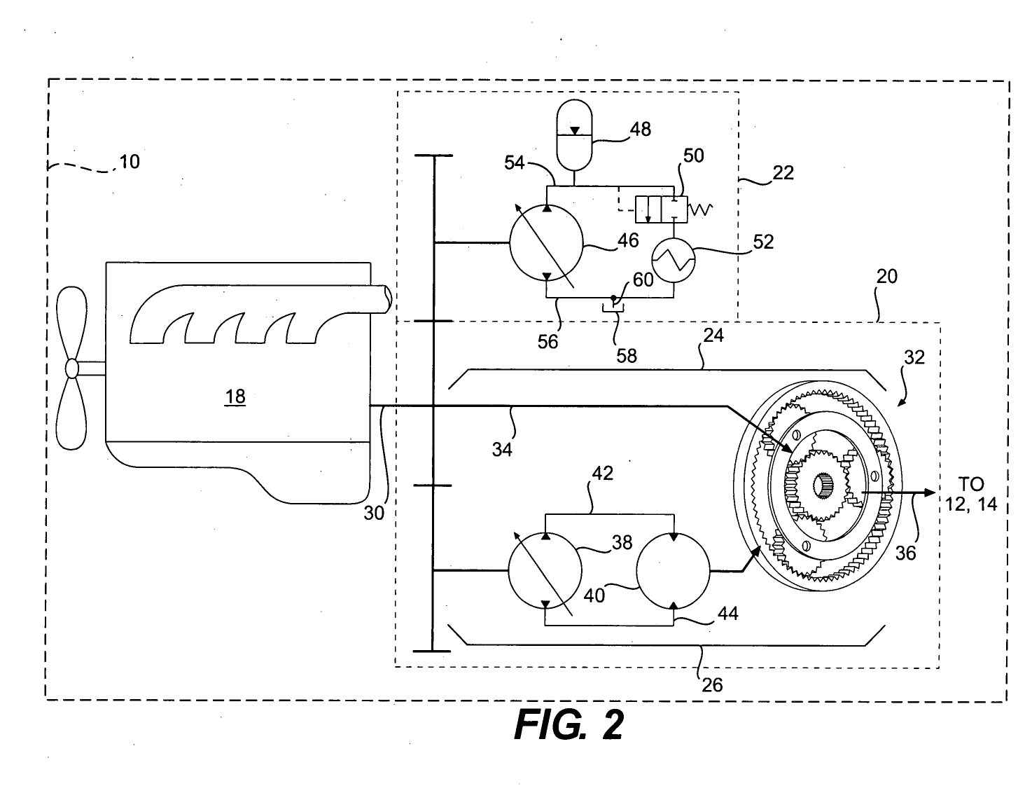

As illustrated in FIG. 2, transmission 20 may have multiple flow paths to transmit power from power source 18 to traction devices 12, 14. In particular, transmission 20 may include a first power flow path 24 extending through a multi-speed, bidirectional, mechanical transmission, and a second power flow path 26 extending through a hydraulic or electric continuously variable transmission (CVT). First and second power flow paths 24, 26 may be disposed in series or parallel, originate from a mechanical output 30 of power source 18, and have a common portion through one or more gear assemblies 32 (only one shown in FIG. 2). It is to be noted that, although a parallel path transmission configuration having a common portion is illustrated in FIG. 2, the CVT portion of a parallel path series configuration may not have any commonality with the mechanical transmission. Gear assemblies 32 may be disposed between a mechanical input 34 and a mechanical output 36 of transmission 20. Multiple fluid activated clutches (not shown) may also be included within transmission 20. The clutches may selectively fill with pressurized fluid causing engagement of portions of the gear assemblies. The combination of engaged clutches may determine the stepped output speed ratio of transmission 20.

The CVT portion or second power flow path 26 within transmission 20 may include a pump 38 and a motor 40 interconnected by way of a first fluid passageway 42 and a second fluid passageway 44. Pump 38 may be, for example, a variable displacement pump rotated by mechanical output 30 of power source 18 to pressurize fluid. The pressurized fluid may be directed through motor 40 by way of fluid passageways 42 or 44, depending on the travel direction of machine 10. Motor 40, being driven by the pressurized fluid may rotate a portion of gear assembly 32. The direction and speed of this rotation may affect the output ratio of transmission 20. A ratio controller (not shown) may manipulate the displacement of pump 38 with a pump signal to thereby control the rotation of motor 40 and the resulting output ratio of transmission 20. It is contemplated that motor 40 may also be a variable displacement device, if desired. It is to be noted that in an electric CVT configuration, a generator and electric motor may substitute for the fluid pump and motor described above.

Hydraulic assist unit 22 may include components that interact to selectively absorb energy from and release energy to mechanical output 30 of power source 18. Specifically, hydraulic assist unit 22 may include a pump 46, an accumulator 48, a pressure relief valve 50, and a cooler 52. Pump 46 may be fluidly connected to accumulator 48 by way of a fluid passageway 54, and with cooler 52 by way of a fluid passageway 56. Although pressure relief valve 50 illustrated as being disposed between accumulator 48 and cooler 52 within fluid passageway 54, it is contemplated that pressure relief valve 50 may be disposed at any location within hydraulic assist unit 22. It is contemplated that one or more control valves (not shown) may be implemented within hydraulic assist unit 22 such as, for example, within fluid passageways 54 between pump 46 and accumulator 48, within fluid passageway 56, and/or within a drain passageway 60 associated with a lower pressure reservoir 58 to control flow operations within hydraulic assist unit 22, if desired.

Similar to pump 38, pump 46 may also be a variable displacement source of pressurized fluid. During steady state operation of machine 10, the displacement of pump 46 may be set to approximately zero to minimize the friction added by pump 46 to power source 18. However, during situations of excess engine power, the displacement of pump 46 may be increased to pressurize and store pressurized fluid within accumulator 48 for later use. Similarly, during situations of insufficient power, the displacement of pump 46 may be increased and the stored pressurized fluid within accumulator 48 discharged to drive power source 18 by way of pump 46.

Accumulator 48 may embody a pressure vessel filled with a compressible gas that is configured to store pressurized fluid for future use as a source of fluid power. The compressible gas may include, for example, nitrogen or another appropriate compressible gas. As fluid in communication with accumulator 48 exceeds a predetermined pressure, it may flow into accumulator 48. Because the nitrogen gas is compressible, it may act like a spring and compress as the fluid flows into accumulator 48. When the pressure of the fluid within passageways communicated with accumulator 48 drops below a predetermined pressure, the compressed nitrogen within accumulator 48 may expand and urge the fluid from within accumulator 48 to exit accumulator 48. It is contemplated that accumulator 48 may alternatively embody a spring biased type of accumulator, if desired.

Pressure relief valve 50 may fluidly connect the output of pump 46 to low pressure reservoir 58 by way of fluid passageways 56 and 60 to relieve pressure from hydraulic assist unit 22. In particular, pressure relief valve 50 may include a pilot or solenoid operated valve element that is spring-biased toward a closed or fluid-blocking position and movable toward an open or fluid-passing position in response to a pressure within fluid passageway 54 exceeding a predetermined pressure. The predetermined pressure may be variable, if desired, and set or varied according to one or more machine related conditions. Pressure relief valve 50 may maintain system pressure (e.g., the pressure within hydraulic assist unit 22) at the predetermined level by remaining in the fluid-blocking position until the pressure of the fluid acting on pressure relief valve 50 exceeds the biasing spring force and/or the solenoid (not shown) is energized, while simultaneously protecting the system from excessive pressure spikes. The system pressure within hydraulic assist unit 22 may act against the pressurizing work of pump 46, thereby, allowing excess power to be dissipated even when accumulator 48 is filled to capacity. It is contemplated that pressure relief valve 50 may be omitted, if desired.

As pump 46 works the fluid within hydraulic assist unit 22, the dissipated energy may be converted into heat. If left unchecked, this heat could build up and reduce the effectiveness of hydraulic assist unit 22. For this reason, cooler 52 may be utilized to exchange heat with a secondary fluid circuit (not shown). Cooler 52 may embody any type of heat exchanger known in the art such as, for example, a plate-type, tube and fin-type, or shell and tube-type liquid-to-air heat exchanger or a liquid-to-liquid heat exchanger.

### INDUSTRIAL APPLICABILITY

The disclosed drivetrain may provide a flexible and robust way to improve vehicle response, regardless of the type of transmission utilized within the vehicle. Specifically, the separate and self-contained hydraulic assist unit of the disclosed drivetrain may selectively provide added power to the primary mover of the vehicle for acceleration and added friction for deceleration. Because this hydraulic assist unit may includes its own source of power and power storage, it can be used in conjunction with a mechanical transmission, an electric transmission, a hydraulic transmission, or any combination of these technologies. The operation of machine 10 will now be described.

Referring to FIG. 2, when machine 10 is in operation, power source 18 may combust a fuel/air mixture to produce mechanical output 30. The power associated with mechanical output 30 may be transmitted to traction devices 12 and 14 along dual flow paths 24 and 26. As power is transmitted along first flow path 24, a machine operator may select a desired transmission output gear ratio or a maximum transmission output speed ratio by moving an operator interface device (not shown). When the operator selects a particular gear ratio or the gear ratio is automatically selected in response to a travel speed or torque and a maximum allowable gear ratio, select clutches associated with first power flow path 24 may fill with pressurized fluid and engage select combinations of gear assemblies to cause transmission 20 to step between predefined output ratios. Similarly, as a speed and/or a torque output demand at traction devices 12, 14 changes, pump 38 within second power flow path 26 may pressurize fluid and direct the pressurized fluid to motor 40. In turn, motor 40 may mechanically rotate a portion of gear assembly 32, thereby modifying the selected output ratio of transmission 20 to simultaneously provide desired vehicle output and optimum engine performance at that output.

As transmission 20 changes output gear ratios, particularly stepwise changes in the output ratio, power source 18 may have difficulty immediately supplying the required output torque. As a result, the operation of power source 18 may, in some situations, lag desired performance. In order to accommodate this lag in performance, hydraulic assist unit 22 may selectively supply and absorb the torque difference between demanded torque and engine-available torque. For example, when shifting from a low gear ratio to a high gear ratio, the output torque of power source 18 may lag a desired output torque, causing the speed of the engine to drop undesirably. In this situation, pressurized fluid from accumulator 48 may be directed to drive pump 46 and add torque to mechanical output 30. Conversely, when shifting from a high gear ratio to a low gear ratio, the output torque of power source 18 may be higher than demanded and, because of the lack of friction due to undersizing of power source 18, the output torque decrease of power source 18 may lag a desired torque decrease. In this situation, the excess torque of power source 18 may directed through mechanical output 30 to drive pump 46 and pressurize fluid within hydraulic assist unit 22. By driving pump 46, the friction and, thus, the ability to quickly reduce the torque output of power source 18 may be increased. In addition, the fluid pressurized by pump 46 may be directed to charge accumulator 48 for the next assisting operation. When neither torque addition nor subtraction is necessary and accumulator 48 is filled to capacity, the displacement of pump 46 may be de-stroked such that the efficiency of power source 18 is largely unaffected.

Hydraulic assist unit 22 may selectively add friction to power source 18, even when accumulator 48 is filled to capacity. Specifically, because hydraulic assist unit 22 includes pressure relief valve 50, system pressure, which acts against the rotation of pump 46, may be maintained at a desired predetermined level, regardless of a condition of accumulator 48.

It will be apparent to those skilled in the art that various modifications and variations can be made to the drivetrain of the present disclosure. Other embodiments of the drivetrain will be apparent to those skilled in the art from consideration of the specification and practice of the invention disclosed herein. It is intended that the specification and examples be considered as exemplary only, with a true scope of the disclosure being indicated by the following claims and their equivalents.

What is claimed is:

1. A drivetrain, comprising:
a combustion engine having a mechanical output;
a ground engaging traction device;
a primary transmission unit connected to transmit power from the mechanical output to the ground engaging traction device; and
a hydraulic power assist unit operatively connected to the mechanical power output to selectively drive the combustion engine.

2. The drive train of claim 1, wherein the hydraulic assist is further configured to selectively retard the motion of the ground engaging device.

3. The drivetrain of claim 1, wherein the hydraulic power assist unit includes:
a pump driven by the mechanical power output to pressurize fluid; and
an accumulator configured to selectively store and release the pressurized fluid.

4. The drivetrain of claim 3, wherein:
storage of the pressurized fluid in the accumulator results in motion retarding of the ground engaging device;
the power assist unit includes a pressure relief valve; and
the motion retarding is available even when the accumulator is completely filled with fluid.

5. The drive train of claim 3, wherein the pump is a variable displacement pump and the displacement of the pump is set to approximately zero during steady state operation of the combustion engine.

6. The drivetrain of claim 1, wherein the primary transmission unit includes a mechanical step change transmission operatively connected to the mechanical power output.

7. The drivetrain of claim 6, wherein the primary transmission unit further includes a drive pump operatively driven by the mechanical output to pressurized fluid.

8. The drivetrain of claim 7, wherein:
the mechanical step change transmission includes a gear assembly; and
the primary transmission also includes a motor fluidly connected to receive the pressurized fluid from the drive pump and to operatively drive a portion of the gear assembly.

9. A method of propelling a vehicle, comprising:
combusting fuel to produce a mechanical output;
directing power through a first flow path to propel the vehicle, the first flow path originating from the mechanical output;
selectively directing power through a second flow path to pressurize a fluid, the second flow path being completely different from the first flow path and originating from the mechanical output;
storing the pressurized fluid; and
selectively directing the stored pressurized fluid back through the second flow path to propel the vehicle.

10. The method of claim 9, further including directing power through a third flow path to propel the vehicle, the third flow path originating from the mechanical output.

11. The method of claim 10, wherein at least a portion of the first and third flow paths are common.

12. The method of claim 9, further including step changing an output speed through the first flow path.

13. The method of claim 12, wherein, if a step change decreasing the output speed ratio has been made, the stored pressurized fluid is directed back through the second flow path.

14. The method of claim 13, wherein, if a step change increasing the output speed ratio has been made, the pressurized fluid is directed through the second flow path and stored.

15. A vehicle, comprising:
a combustion engine having a mechanical output;
a driven traction device;
a steerable traction device;
a frame operatively connecting the combustion engine, the driven traction device, and the steerable traction device;
a primary transmission unit connected to transmit power from the mechanical output to the driven traction device; and
a hydraulic power assist unit operatively connected to the mechanical power output to selectively drive the combustion engine.

16. The vehicle of claim 15, wherein the hydraulic assist is further configured to selectively retard the motion of the driven traction device.

17. The vehicle of claim 15, wherein the hydraulic power assist unit includes:
a pump driven by the mechanical power output to pressurize fluid; and
an accumulator configured to selectively store and release the pressurized fluid.

18. The vehicle of claim 17, wherein:
storage of the pressurized fluid in the accumulator results in motion retarding of the ground engaging device;
the power assist unit includes a pressure relief valve; and
the motion retarding is available even when the accumulator is completely filled with fluid.

19. The vehicle of claim 17, wherein the pump is a variable displacement pump and the displacement of the pump is set to approximately zero during steady state operation of the combustion engine.

20. The vehicle of claim 15, wherein the primary transmission unit includes:
a mechanical step change transmission operatively connected to the mechanical power output and having a gear assembly;
a drive pump operatively driven by the mechanical output to pressurized fluid; and
a motor fluidly connected to receive the pressurized fluid from the drive pump and to operatively drive a portion of the gear assembly.
